(19) United States
(12) Patent Application Publication
(10) Pub. No.: US 2002/0175195 A1
(43) Pub. Date: Nov. 28, 2002

(54) Smokeless tobacco container with display surfaces for advertising indicia

(76) Inventor: Stephen W. Cole, Edmond, OK (US)

Correspondence Address: MARY M LEE, P.C., 3441 W. MEMORIAL ROAD, SUITE 8, OKLAHOMA CITY, OK, 73134

(21) Appl. No.: 10/151,655

(22) Filed: May 20, 2002

Related U.S. Application Data
(60) Provisional application No. 60/293,583, filed on May 24, 2001.

(51) Int. Cl. A45F 5/00; B60R 7/05

(52) U.S. Cl. 224/269; 224/312

(57) ABSTRACT

A holder for a container of smokeless tobacco. The holder provides a vehicle for advertising and can be removably attached to a automobile visor, belt or waistband, golf cart or the like. In its preferred form, the holder is a semi-cylindrical frame with an open top and side. In this way, the inner and outer surfaces of the side wall, as well as the inner surface of the back wall, are visible when the container is not in the holder. When the container is in the holder, the outer side wall is still visible. These visible surfaces are ideal as display surfaces for advertising indicia, which can relate to the brand of smokeless tobacco or to any other advertising subject matter. The holder is inexpensive and can be provided as an advertising “give-away” or sold with the smokeless tobacco as a promotional item.

This application claims the benefit of the filing date of provisional application No. 60/293,583, filed May 24, 2001, entitled “Smokeless Tobacco Container Holder with Display Surfaces for Advertising Indicia,” the content of which is incorporated herein by reference.

### FIELD OF THE INVENTION

The present invention relates generally to holders for smokeless tobacco containers.

### BACKGROUND OF THE INVENTION

Advertising is critical to most businesses for promoting the sale of products or services. Advertisers and marketing directors constantly are searching for news ways to communicate information about their products to potential customers. Tobacco companies, in particular, are disadvantaged in the realm of advertising, as state and federal laws severely restrict their advertising to certain types of media and locations.

Most smokeless tobacco, also called “dip” or “snuff,” comes in small cylindrical cans. Usually, these cans display the tobacco brand name or logo, or both, prominently on the top of the lid of the can. This is an effective display of the brand indicia, but it usually is visible only when the can is in use. At other times, the can is kept in a pocket or drawer. When the user is driving or riding in an automobile, the can may be dropped in the console or kept in the glove compartment. When mixed with the other objects commonly kept in such locations, the tobacco container may be difficult to retrieve especially while driving.

The present invention provides a convenient way to mount the tobacco container for ready access by users. The small holder can be clipped or otherwise removably attached to a vehicle visor, a golf bag, a belt or the waistband on clothing. At the same time, the holder provides multiple display surfaces for advertising indicia. While mounted on a visor or belt, for example, the outer side wall of the holder is always visible, as is the top of the lid of the container when it is in the holder. When the container is removed, the inner back wall and side wall of the empty holder are also readily visible, and provide additional advertising display surfaces.

### SUMMARY OF THE INVENTION

The present invention comprises a holder for a smokeless tobacco container, the holder comprising a frame. The frame defines a container-receiving space shaped to receive and support the smokeless tobacco container. A first indicia display surface is provided on the frame. The holder further comprises a connector on the frame adapted to removably connect the holder to an object.

### BRIEF DESCRIPTION OF THE DRAWINGS

FIG. 1 is a plan view of a smokeless tobacco container in accordance with a preferred embodiment of the present invention.

FIG. 2 is a bottom view of the smokeless tobacco container of FIG. 1.

FIG. 3 is a side elevational view of the smokeless tobacco container holder of FIG. 1.

FIG. 4 is a front elevational view of the smokeless tobacco container holder of FIG. 1.

FIG. 5 is a rear elevational view of the smokeless tobacco container holder of FIG. 1.

FIG. 6 is a fragmented view of the inside front windshield area of an automobile with the smokeless tobacco container holder clipped to the visor and illustrating the visibility of a first indicia display through the top opening therein.

FIG. 7 is a fragmented side view of the inside front windshield of the vehicle shown in FIG. 6 illustrating the visibility of a second indicia display surface on the outside of the holder.

### DETAILED DESCRIPTION OF THE PREFERRED EMBODIMENTS

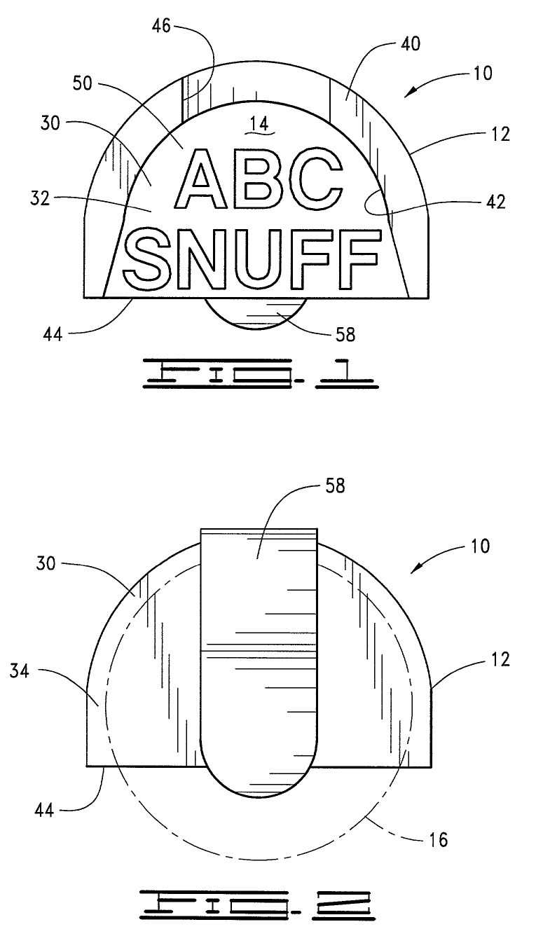

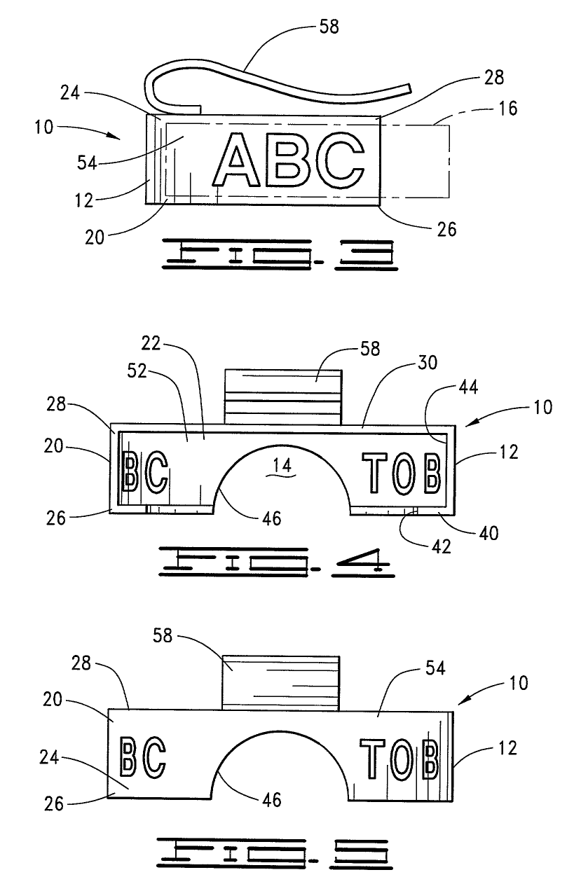

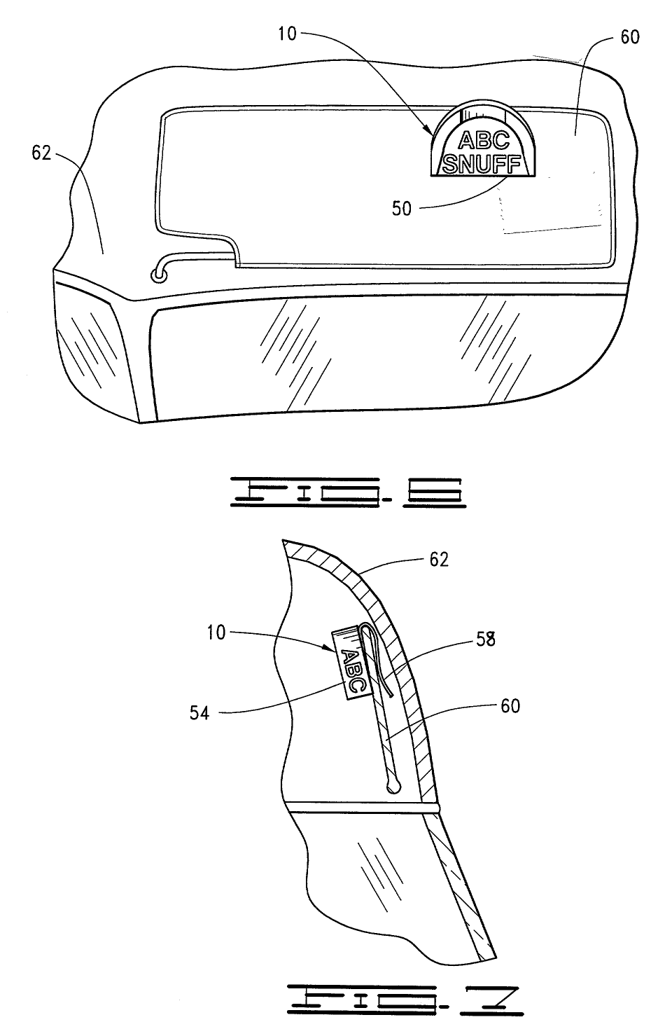

Turning now to the drawings in general and to FIGS. 1-5 in particular, there is shown therein a holder for a smokeless tobacco container made in accordance with the present invention and designated generally by the reference numeral 10. The holder 10 comprises a frame 12 that defines a container-receiving space 14 shaped to receive and support the container 16 (shown in phantom in FIGS. 2 and 3 only).

As used herein, “smokeless tobacco container” means any container in which smokeless tobacco is sold or carried, including but not limited to cans, packets, sacks, pouches, jars, or tubes. One common container for smokeless tobacco is a short cylindrical can. Thus, for purposes of illustration, and without meaning to be limited thereby, the preferred embodiment illustrated herein is sized and shaped to receive and support this cylindrically shaped container.

It will be understood that the configuration of the frame will be modified depending on the shape and size of the container. For example, the frame could be a tube or sleeve, either forming a complete cylinder or a cylinder with an elongate opening along the length of its side wall. Alternately, the frame could be a flat box, trough, pouch or packet, a ring, or virtually any other shape or configuration depending on the container to be supported therein.

The frame 10 can take many forms. As illustrated herein, the frame is solid and integrally formed and may be molded of plastic or other moldable materials. However, the frame may be formed of straps or wires or wire or metal mesh or woven materials. Virtually any material may be used so long as it is sturdy enough to support the tobacco container during use and can support indicia display surfaces thereon.

In the preferred embodiment, at least one indicia display surface is provided on the surface of the frame 10. More preferably, the frame 10 provides a second indicia display surface. Most preferably, the frame 10 provides a third indicia display surface. The specific number and location of the display surfaces may vary depending on the shape of the frame 10.

As indicated previously, the embodiment shown herein is shaped to receive a cylindrical can. To that end, the frame 12 may be shaped like a half-cylinder to define a semi-cylindrical container-receiving space 14. Specifically, the preferred frame 12 comprises a side wall 20 having an inner and outer surface 22 and 24. The side wall 20 has a top and bottom edge 26 and 28. A back wall 30 is included to enclose the bottom or back of the frame 10. The back wall 30 has an inner and an outer surface 32 and 34. The back wall 30 is attached to the bottom edge 28 of the side wall 20.

Referring still to FIGS. 1-5, the frame 12 preferably further comprises a lip 40 extending inwardly from the top edge 26 of the side wall 20. The lip 40 is generally parallel to the inner surface 32 of the back wall 30. The lip 40 defines, at least partially, a top opening 42 through which the inner surface 32 of the back wall 30 is visible.

The side wall 20 includes a front opening 44 sized to permit the insertion of the container 16 into the frame 12. The front opening 44 also permits visibility of the inner surface 22 of the side wall 20. In most instances, it will be desirable to provide a push hole 46 in the side wall 20 generally opposite the front opening 44.

Now it will be appreciated that that by sizing the frame 12 according to the dimension of the container 16, the semi-cylindrical frame with its front opening 44 will permit easy, one-step insertion of the container. The container 16 is simply pushed or slid into the frame 12 through the front opening 44 between the lip 40 and back wall 30 and is frictionally held therein. Removal of the container 16 is just as simple. The user simply uses his finger to push on the side of the container 16 through the push hole 46 until it slips out of the front opening 44 on the opposite side.

A frame 12 with this preferred configuration thus provides the preferred three indicia display surfaces described above. One display surface is provided by the inner surface 32 of the back wall 30; another display surface is provided on the inner surface 22 of the side wall 20; and a third display surface is provided on the outer surface 24 of the side wall. It will be understood, that in some applications, the frame may have only one or two display surfaces, and these may be located in any combination of the three possible surfaces of the preferred embodiment described herein. Thus, when “first,” “second” and “third” are used herein to distinguish the several display surfaces, the ordinal term is not meant to specify only a single possible location. Accordingly, a first display surface 50 is provided on the inner surface 32 of the back wall 30; a second display surface 52 is provided on the inner surface 22 of the side wall 20; and a third display surface 54 is provided on the outer surface 24 of the side wall.

As described previously, it will be desirable to attach the holder 10 from time to time to an object. For example, the holder may be attached to a pocket, waistband, belt, golf bag, back pack, the edge of a countertop or work surface, or the sun visor of a vehicle. For this purpose, the holder 10 preferably includes a connector on the frame adapted to removably attach the holder to an object. The connector may be any of a wide variety of devices, including but not limited to loops, straps, adhesives, spring-biased clips or brackets, suction cups or Velcro brand hook and loop fasteners.

In the embodiment illustrated herein, the connector is a resilient clip 58. This makes the holder 10 suited for attachment to a variety of objects. For example, as shown in FIGS. 6 and 7, the clip 58 is especially convenient for attaching the holder 10 to the sun visor 60 in an automobile or truck 62. This makes the container 16 (FIGS. 2 and 3) visible and within a short reach of the driver.

As will also be apparent from FIGS. 6 and 7, the display surfaces 50, 52 and 54 of the empty holder 10 are readily visible to the driver as well as to the passengers in the front and back seats. Although not shown in FIGS. 6 and 7, when the container 16 (FIGS. 1 and 3) is in the holder 10, the indicia display surface 54 on the outer surface 24 of the side wall 20 remains visible. In addition, the logo or other indicia on the top of the can will be seen through the top opening 42 of the holder 10.

Changes can be made in the combination and arrangement of the various parts and steps described herein without departing from the spirit and scope of the invention.

What is claimed is:

1. A holder for a smokeless tobacco container, the holder comprising:
a frame defining a container-receiving space shaped to receive and support the smokeless tobacco container;
a first indicia display surface on the frame; and
a connector on the frame adapted to removably connect the holder to an object.

2. The holder of claim 1 wherein the connector is a resilient clip.

3. The holder of claim 2 wherein the smokeless tobacco container is cylindrical and wherein the receiving space defines at least a partial cylinder.

4. The holder of claim 3 wherein the frame comprises a back wall having an inner surface, a side wall having an inner and outer surface, a top opening through which the inner surface of the back wall is visible, a front opening through which the inner surface of the side wall is visible, wherein the holder further comprises a second indicia display surface and a third indicia display surface, wherein the inner surface of the back wall comprises one of the first, second and third display surfaces, wherein the inner surface of the side wall comprises another of the first, second and third display surfaces, and wherein the outer surface of the side wall comprises the remaining one of the first, second and third display surfaces.

5. The holder of claim 1 further comprising a second indicia display surface.

6. The holder of claim 5 further comprising a third indicia display surface.

7. The holder of claim 6 wherein the frame comprises a back wall having an inner surface, a side wall having an inner and outer surface, a top opening through which the inner surface of the back wall is visible, a front opening through which the inner surface of the side wall is visible, wherein the inner surface of the back wall comprises one of the first, second and third display surfaces, wherein the inner surface of the side wall comprises another one of the first, second and third display surfaces, and wherein the outer surface of the side wall comprises the remaining one of the first, second and third display surfaces.

8. The holder of claim 7 wherein the container is cylindrical and wherein the receiving space defines at least a partial cylinder.

9. The holder of claim 8 wherein the side wall has a bottom edge and a top edge, the back edge abutting the back wall of the frame, and wherein the frame further comprises a lip extending inwardly from the top edge of the side wall and which at least partially defines the top opening.

10. The holder of claim 9 wherein the front opening is formed by the side wall, wherein the side wall defines a push hole positioned generally opposite the front opening, whereby the container can be inserted into the frame through the front opening and pushed out of the front opening by applying pressure to the container through the push hole.

11. The holder of claim 5 wherein the container is cylindrical and wherein the receiving space defines at least a partial cylinder, wherein the frame further comprises a second indicia display surface, wherein the frame comprises a back wall having an inner surface, a side wall having an inner and outer surface, a top opening through which the inner surface of the back wall is visible, a front opening through which the inner surface of the side wall is visible, wherein the first indicia display surface is on one of the inner surface of the back wall, the inner surface of the side wall and the outer surface of the side wall, and wherein the second indicia display surface is on another one of the inner surface of the back wall, the inner surface of the side wall and the outer surface of the side wall.

12. The holder of claim 11 wherein the frame comprises a third indicia display surface on a third one of the inner surface of the back wall, the inner surface of the side wall and the outer surface of the side wall.

13. The holder of claim 1 wherein the container is cylindrical and wherein the receiving space defines at least a partial cylinder.

14. The holder of claim 13 wherein the frame comprises a back wall having an inner surface, a side wall, a top opening through which the inner surface of the back wall is visible, and wherein the first indicia display surface is on the inner surface of the back wall.

15. The holder of claim 13 wherein the frame comprises a back wall, a side wall having an inner surface, and a front opening through which the inner surface of the side wall is visible, and wherein the first indicia display surface is on the inner surface of the side wall.

16. The holder of claim 13 wherein the frame comprises a back wall and a side wall having an outer surface, and wherein the first indicia display surface is on the outer surface of the side wall.

17. The holder of claim 1 wherein the container is cylindrical, wherein the receiving space of the holder defines at least a partial cylinder, wherein the frame comprises a side wall having a top edge and a bottom edge, a back wall attached to the bottom edge of the side wall, an inwardly extending lip on the top edge of the side wall which at least partially defines a top opening, and a front opening through which the container can be inserted into the holder, and wherein the side wall defines a push hole positioned generally opposite the front opening whereby the container can be pushed out of the frame through the front opening by applying pressure to the container through the push hole.

18. The holder of claim 17 wherein the connector is a resilient clip.
